(19) United States
(12) Patent Application Publication
(10) Pub. No.: US 2002/0069081 A1
(43) Pub. Date: Jun. 6, 2002

(54) Methods and systems for providing employment management services over a network

(76) Inventors: Aubrey Lee Ingram, Newburyport, MA (US); William F. Nazzaro, Collegeville, PA (US); Andrew Trice, Arlington, VA (US); Michael J. Waluk, Richmond, RI (US); Jeff Dooley, Framingham, MA (US); Kenneth F. Phillips, Natick, MA (US); Scott Bennett, Belmont, MA (US)

Correspondence Address: FOLEY, HOAG & ELIOT, LLP, PATENT GROUP, ONE POST OFFICE SQUARE, BOSTON, MA, 02109, US

(21) Appl. No.: 09/998,154

(22) Filed: Oct. 31, 2001

Related U.S. Application Data
(60) Provisional application No. 60/244,513, filed on Oct. 31, 2000.

(51) Int. Cl. G06F 15/173

(52) U.S. Cl. 705/1

(57) ABSTRACT

The present disclosure is directed to systems and methods for providing employment management services to a user via a network. The systems disclosed herein can comprise a portal server hosting at least a portion of an employment management services accessible to a user via a client system, at least one business application, wherein said at least one business application concerns an employment service which is offered to the user, at least one database of information concerning an employment service which is offered to the user, and wherein the employment management services includes a user interface comprising controls whereby the user submits information. The system can assist a services manager in managing employment services being offered to the user. The methods disclosed herein include providing a user interface having controls to a user to access an employment management services, receiving first information from the user via the controls; and processing the received information to provide an employment service to the user.

### REFERENCE TO RELATED U.S. APPLICATIONS

This application claims priority to United States Provisional Patent Application No. 60/244,513, filed Oct. 31, 2000, the entire contents of which are herein incorporated by reference.

### BACKGROUND

This application disclosure relates generally to providing services over a communications network, and more particularly to systems and methods for providing employment management services over a communications network.

Enterprises today need to extend their reach, reduce their costs, and lower their response times by providing easy-to-access services to their customers, partners, employees and suppliers. Typically, applications that provide these services must combine existing enterprise information systems with new business functions that deliver services to a broad range of users. One way to accomplish this can be to integrate an enterprise's infrastructure applications onto one system platform. Integrated systems such as this should be able to handle the processing capabilities of an enterprise's business application such as an employee self-service application, a manager self-service application, a workforce management application, a payroll services application, a human resources services application, an enterprise resource planning services application and a marketplace services application, amongst others. And such an integrated platform should be (i) highly available to meet the needs of today's global business environment, (ii) secure, to protect the privacy of users and the integrity of enterprise data, and (iii) reliable and scalable, to insure that business transactions are accurately and promptly processed.

### SUMMARY

In a competitive labor market, employers are looking for new ways to attract and retain the best employees. The systems and methods described herein can extend the power of self-service by enabling users such as employees to interact directly with employer-approved suppliers, allowing clients to broaden their benefits offerings without significant costs or administrative burdens, all within one integrated platform.

Such enterprise applications (e.g., integrated platform) require a level of flexibility and scalability that challenge most organizations. The emergence of the Internet as an operating environment in which applications run has set a new standard in terms of availability and performance demanded by users. The speed at which technology is moving coupled with the increasing application requirements from enterprises encouraged software developers to take advantage of state-of-the-art tools and techniques. The use of proprietary tools and techniques is no longer acceptable by end users and ultimately slows the product development process by preventing developers from using standardized programming methods. It is with these requirements in mind that a framework architecture for future application delivery based on the requirements of openness, scalability, reliability and security has been developed.

As such, systems and methods for providing employment management services to a user via a network to are disclosed herein. In accordance with an aspect of the present disclosure, the system can include a portal server hosting at least a portion of an employment management services accessible to a user via a client system, at least one business application, wherein the at least one business application concerns an employment service which is offered to the user, at least one database of information concerning an employment service which is offered to the user, at least one application server to communicate with the portal server and the at least one business application, at least one application database of information, wherein the at least one application database of information includes data associated with the user, and wherein the employment management services comprising a user interface comprising controls whereby the user submits information and wherein the employment management services is available via a network to assist at least one services manager in managing employment services being offered to the user. The services manager may be an employer of the user or may be a third party supplier who provides services to the user. The business applications may include an employee self-service application, a manager self-service application, a workforce management application, a payroll services application, a human resources services application, an enterprise resource planning services application and a marketplace services application, amongst others. The client system may include at least one of the following: a computer, a telephone, a wireless communication device, an information kiosk, a fax device, a television and a call center.

In other embodiments, the user interface further comprises a portal wherein the controls of the user interface are provided within the portal.

In accordance with another aspect of the present disclosure, the user interface can further include an authentication module to authenticate an identity of the user, wherein the authentication module compares the submitted information to information stored in the at least one database of information, and an authorization module to determine which employment services are available to the user.

In accordance with yet another aspect of the present disclosure, the user interface can also include a security module to protect information exchanged within the system. The security module may utilize a secure sockets layer protocol.

In accordance with a further aspect of the present disclosure, the systems and methods disclosed herein can include a workflow module, wherein the workflow module can direct the presentation of the controls within the user interface based upon a received user request for information, and a business rules engine, wherein the business rules engine also can control the presentation of the user interface.

In accordance with other aspects of the present disclosure, the systems and methods disclosed herein can further utilize a business logic module.

In accordance with another aspect of the present disclosure, some embodiments may include a session management module.

In accordance with yet another aspect of the present disclosure, some systems and methods disclosed herein may utilize a data integration module to update information stored in at least one database of information.

In accordance with further aspect of the present disclosure, an event-based navigation module may utilized, wherein the events-based navigation module bundles a plurality of controls to be presented to the user via the user interface. The event-based navigation module may bundle the plurality of controls to be presented to the user via the user interface based upon information received from the user. Also, the plurality of controls that are bundled by event-based navigation module may be associated with a plurality of business applications. In some embodiments, the bundled plurality of controls can be presented to the user, via the user interface, in a common format.

Other objects of the systems and methods described herein will, in part, be obvious, and, in part, be shown from the descriptions and Figures which are presented below.

### BRIEF DESCRIPTION OF DRAWINGS

FIG. 1 shows one embodiment of the architecture used in a employment management services system;

FIG. 2 shows one embodiment of a system for proving employment management services via a network;

FIG. 3 shows one embodiment of a work and life event string;

FIG. 4 shows one embodiment of a portal having controls;

FIG. 5 shows another embodiment of a system for proving employment management services via a network;

FIG. 6 shows one embodiment of Data Access Layer interaction; and

FIG. 7 shows an user interface comprising a plurality of controls having a common format.

### DETAILED DESCRIPTION OF THE PREFERRED EMBODIMENT(S)

The systems and methods described herein may be implemented by adopting and utilize the Java 2 Enterprise Edition (J2EE) platform. Utilizing the J2EE platform may reduce the cost and complexity of developing the multi-tiered services described herein and may result in services that can be rapidly deployed and enhanced as these systems and methods evolve and respond to today's ever-changing business environment. The J2EE application model may also be advantageous because it is designed to support applications that implement cross-enterprise services amongst a plurality of users, for example, one's customers, employees, suppliers and partners. Such applications are inherently complex, potentially accessing data from many internal and external sources and providing a variety of client interface options for these distributed services.

To better control and manage these applications, the business functions to support these various users may be conducted in a middle tier application layer, as described more fully below. The middle tier can generally represents an environment that is closely controlled by an enterprise's (e.g., an organization or company) information technology (IT) department. The middle tier is typically run on a dedicated server and has access to the full services, both internally and externally, of the enterprise. Multi-tier applications may provide the increased accessibility that is now demanded by all elements of an enterprise.

Developing multi-tier services may be complicated by the need to develop both the service's business functions and the more complex infrastructure code required to access databases and other system resources which may exist external to the enterprise. Because each multi-tier server product had its own application model, it may also be difficult to hire and train an experienced development staff. In addition, as service volume increased it has often been necessary to change the whole multi-tier infrastructure to accommodate the increase demands being placed upon the enterprise, which can result in major porting costs and delays.

The use of the J2EE application model may deliver an architecture for implementing multi-tier application services that avoid these problems and deliver the scalability, accessibility, and manageability that is needed.

In using the J2EE application model, the development and integration of a system can be partitions into two parts: the business and presentation logic to be implemented by a developer, and the standard system services provided by the J2EE platform. The developer can rely on the platform to provide the solutions for the systems-level problems of developing a middle-tier service. This model may also provide the benefits of Write Once, Run Anywhere™ portability and scalability for multi-tier applications. This standard model minimizes the cost of developer training while providing the enterprise with a broad choice of J2EE servers and development tools. This application model is a major step forward in simplifying and expediting application development, by minimizing the complexity of building multi-tier applications.

This model may begin with the Java programming language and the Java virtual machine. The proven portability, security, and developer productivity they provide can form the basis of the application model. The application model may also includes the Enterprise JavaBeans™ component model. Enterprise JavaBean approach makes it easy to componentize the Java-based code for common functions, then customize and combine these components visually with JavaBeans development tools.

### The Employment Management Services Enterprise Architecture

The Employment Management Services Enterprise Architecture described herein can be a rapid development environment for new applications that may support the integration of a client's legacy applications into a portal view. Applications running on the platform (i.e., the employment management services system) may drive the portal's work and life events-based navigation via an events-base navigation module, share a common business rules engine, business logic module and workflow engine, and integrate with multiple Enterprise Resource Planning (ERP), payroll, human resources (HR) and other back-office systems. The term Enterprise Resource Planning as used herein should be understood to mean any broad set of activities supported by multi-module application software that may help a manufacturer or other business manage the various parts of its business, which may include, for example, product planning, parts purchasing, maintaining inventories, interacting with suppliers, providing customer service, and tracking orders. ERP, as that term is used herein, may also include application modules for the finance and human resources aspect of a business. Persons skilled in the art will readily recognize other embodiments of ERP systems which fall with the scope of the present disclosure. The key objectives of the systems and methods described herein are:

Component-based design for flexibility and scalability

Open Platform with tightly integrated components

Best of Breed Solution—No proprietary functions, open, standards-based

100% Internet Technology—End-to-End

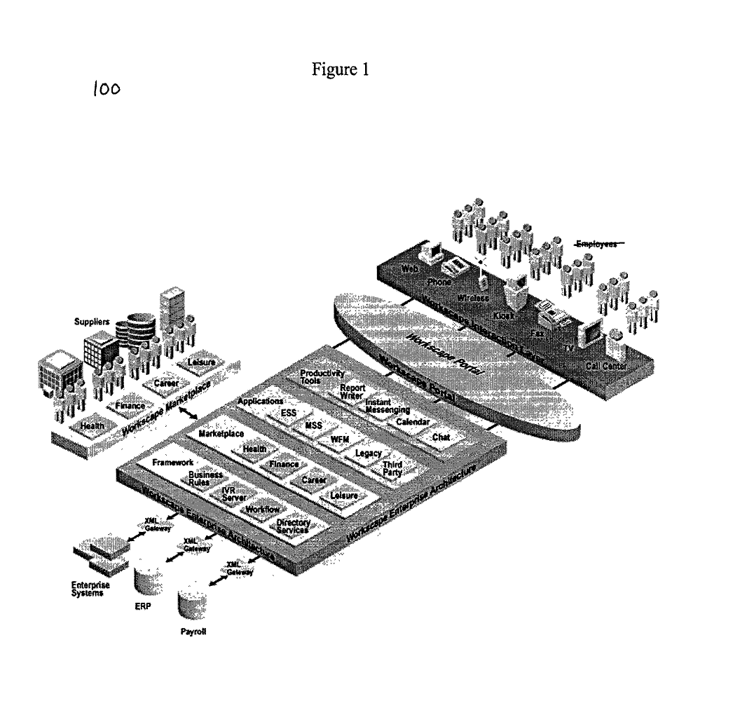

FIG. 1 illustrates a general overview of the architecture layers that may be utilized in an embodiment of an employment management services system 100. To illustrate how the system 100 may address business application, security and scalability requirements, the system 100 will be described in three logical layers: (1) the Presentation or Interaction Layer; (2) the Business Application Logic Layer; and (3) the Data Access Layer. At the highest level, the Interaction Layer may be thought of as the user interface or front door to the to all the underlying business applications, the marketplace and other enterprise services and content. One of the critical roles the Interaction Layer plays is understanding who is accessing the application and what rights they have once they enter the workplace application environment. The Business Application Logic Layer may contain a variety of servers and applications dedicated to delivering the applications the users (e.g., employees, employers and managers) access through the Interaction Layer. Not only are the specific applications themselves running within this Layer, but also so are shared application services like a workflow module and a business rules engine. Finally, the Data Access Layer can provide the integration links (e.g., Internet protocol addresses) to data stored within a database or business application. This data may be stored in a commercial ERP or an HR system. Data may also reside in legacy databases, business applications as well as external third party data sources. The Data Access Layer may make extensive use of a server (e.g, a portal server) in the business application logic layer and XML technology for storing and retrieving data as necessary for the application requested by the user.

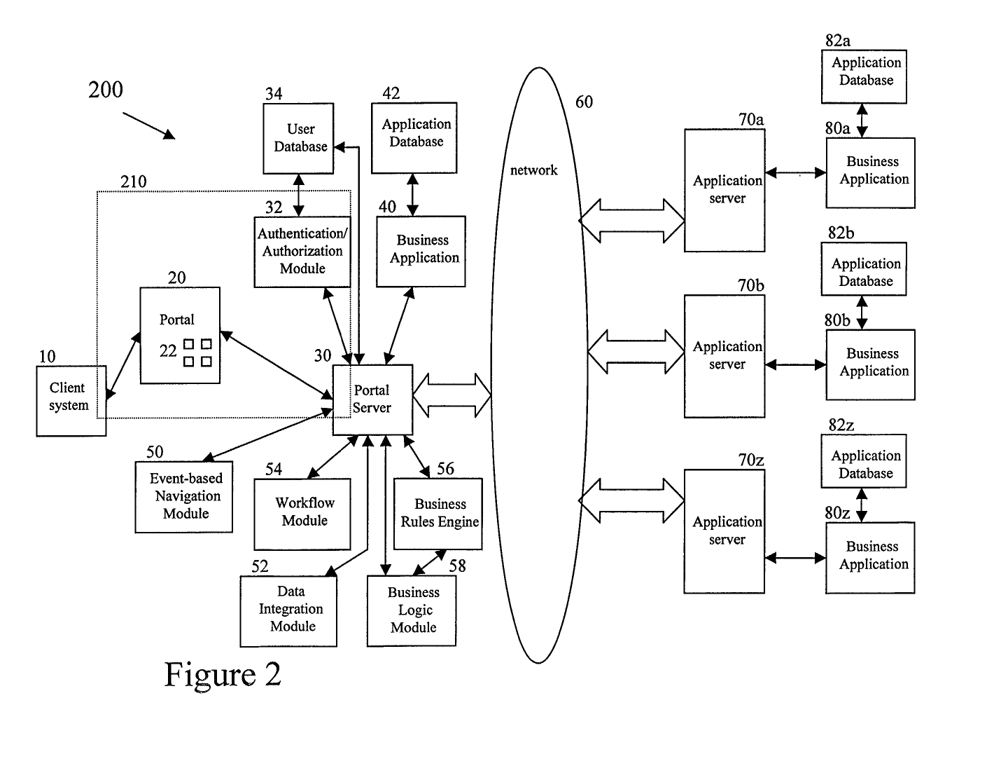

FIG. 2 depicts one embodiment of a system 200 for providing employment management services via a computer network (e.g., 60)—which may be the Internet, a WAN, a LAN, a wireless network, a traditional telephone network, etc.—to assist at least one services manager in managing employment services being offered to a user. A services manager, as that term is used herein, may include any persons or entities who provide an employment service to a user. Thus, a services manager may include an employer of a user, a third party supplier who is affiliated with the employer and a third party supplier who is unaffiliated with the employer, amongst others. Employment services, as that term is used herein, may broadly include any service which is being offered to a user based upon that user's status as an employee. As defined, employment services shall not be limited to just those services which are traditionally provided by an employer to its employees, like the facilitation of a 401(k) retirement plan, for example. Thus, employment services can also include services such as discount purchasing plans, e.g., a Walmart employer discount plan which is available to the employer's employees or similarly arranged discount travel services (i.e., marketplace services).

Specifically, FIG. 2 illustrates a system 200 having a portal server 30 hosting at least a portion of an employment management services accessible to a user via a client system 10, a plurality of business applications 40 and 80a-z accessible via a plurality of applications servers 70a-z (or via portal server 30) wherein the business applications concern employment services which are offered to the user, and a plurality of databases of information 42 and 82a-z concerning employment services which are offered to the user. The portal server 30 can have connections over dedicated channels, or alternatively over non-dedicated channels such as the Internet, to a plurality of client systems 10 and the business applications 40 and 80a-z and the other components of the system 200 depicted in FIG. 2. The portal server 30 may manage many of the services and functions of the user interface 210 (e.g., portal 20). In a preferred embodiment, the system 200 utilizes an iplanet Portal Server, available is available from iplanet E-Commerce Solutions, as its best-of-breed portal server 30 due its proven ability to aggregate data content from a variety of data content sources (e.g., a plurality of business applications 80a-z). Modules and engines deployed on the system 200 may be able to take advantage of many of the benefits of the iPlanet portal platform as follows:

Enables community creation and management

Achieves multi-tiered portal personalization

Delivers integrated content, applications, and services through customizable portal controls and channels

Allows secure extranet access to portal by mobile/remote employees, suppliers, and partners that requires no additional client software to install and maintain

Leverages existing technology and digital asset investments

Integrates native non-web-based Windows NT, Unix X-Server and Mainframe applications

Requires lightweight single sign-on for portal applications

Integrates subscription-based external content

Incorporates a highly scalable and reliable architecture

The terms database and database of information, as these terms are used herein, can mean a wide variety of databases having a collection of data that may be organized so that its contents can easily be accessed, managed and updated as is well known in the art. These databases can include, but are not limited to, relational databases, entity-relational databases, local or distributed databases and object-oriented programming databases, which can include the commercially available Microsoft Access database. The design and development of database systems suitable for use with the system 200, follow from principles known in the art, including those described in McGovern et al., A Guide To Sybase and SQL Server, Addison-Wesley (1993), the contents of which are herein incorporated by reference. The databases of system 200 may be supported by any suitable persistent data memory, such as a hard disk drive, RAID system, tape drive system, floppy diskette, or any other suitable system. The system 200 depicted in FIG. 2 includes databases 34 and 82a-z, for example, that are separate from the portal server 30 and application servers 70a-z, respectively, however, it will be understood by those of ordinary skill in the art that in other embodiments these databases can be integrated into their respective servers.

The system 200 contains a user interaction interface 210 comprising a portal 20 having controls 22 whereby the user can submit information such as identification information, personal information and requests for service and the like.

The business applications 40 and 80a-z of the system 200 can include, but are not limited to, an employee self-service application, a manager self-service application, a workforce management application, a payroll services application, a human resources services application, an enterprise resource planning services application and a marketplace services application. An employee self-service application, as that term is used herein, can include but is not limited to a wide variety of applications that can provide an employee (i.e., a user) an employee-initiated and/or automated service. Examples of an employee self-service application can include: a vacation management and request application wherein an employee can initiate a vacation request; an employee biographical data application wherein an employee can update his or her employer biographical information; and, an employee human resources application wherein an employee can alter his or her claimed W4 exemptions, amongst others. Similarly, a manager self-service application can include, but is not limited to, a wide variety of applications that can provide a manager (i.e., a user) a manager-initiated and/or automated service. Examples of an employee self-service application can include: an employee evaluation application; an employee payroll management application; and, an employee job task assignment application, amongst others.

The client system 10 of the system 200 can be a computer device, a telephone, a wireless communication device, an information kiosk, a fax device, a television, a call center or any other device or system known in the art which is capable of communicating with the user interaction user interface 210 of the system 200. The user interaction interface 210 of the system 200 can include a browser such as a Web browser that can include the Netscape Web browser, the Microsoft Internet Explorer Web browser, the Lynx Web browser, or a proprietary Web browser, or a Web client that allows the client to exchange data with a Web server, an FTP server, a Gopher server, or some other type of network server. Alternatively, if a telephone-based client systems 10 is utilized, the user interaction interface 210 can utilize an Interactive Voice Response (IVR) technology optionally coupled with advanced speech recognition technology (additionally, a telephone-based client systems 10 may also optionally utilize a web browser).

In some embodiments, a user can employs a wireless device client system 10 (e.g., a mobile telephone, a palm pilot, a pager, etc.) to access the user interface 210 over a wireless network (e.g., CDPD, CDMA, GSM, PDC, PHS, TDMA, FLEX, ReFLEX, iDEN, TETRA, DECT, DataTAC, and Mobitex), the Internet, or a conventional telephone network. The user interface 210 can further employ voice recordings to prompt the user to enter information. The user may enter the information by either speaking into the wireless device or by pressing keypads thereon, or by electronic pen.

In some embodiments, the portal server 30 can deliver a HTML-type portal 20 to the client system 10. The HTML-type portal 20 may serve as an user interaction interface 210. The portal 20 can present controls 22 (i.e., user-input fields) to a user using client system 10. By using input devices (not shown) such as a keyboard, a mouse, a touch-screen, touch tone buttons, a voice recognition software application, for example, the user can enter information into the controls 22 of the portal 20 so that the information can be handled, compiled and ultimately delivered to the appropriate business application 42 and 82a-z for processing.

Alternatively, as is discussed in further detail below, in some embodiments the portal server 30 can deliver an XML-type portal 20 to the client system 10. In many embodiments, the portal 20 will have a plurality of controls 22 which are relevant to a plurality of business applications 40 and 80a-z. By utilizing the flexibility of the XML markup language, the plurality of controls 22 within the portal 20 can be presented to the user in a common format regardless of the particular requirements of the individual business applications 40 and 80a-z.

The user interaction interface 210 of system 200 further includes an authentication and authorization module 32 to authenticate an identity of a user and to determine which employment services are available to the user. The user may be prompted within the portal 20 to provide user identification data to the portal server 30 via the controls 22 of the portal 20. The user identification data (i.e., information) may, for example, consist of a login identification and optionally a protected password identifier. The portal server 30 may then provide the user identification data to the authentication and authorization module 32 wherein the authentication and authorization module 32 may consult a user database 34 to authenticate the identity of the user (e.g., by comparing the provided user identification data to user data stored in the user database 34) and establish (i.e., determine) which employment services are available to the user. While the authentication and authorization module 32 is illustrated as one module, the functions of authentication and authorization may be accomplished by separate modules if desired.

The user interaction interface 210 of system 200 can further include a security module (not shown) to protect the information being exchanged within the computer network of system 200. In some embodiments, the security module can utilize a secure sockets layer protocol. One such system is the Netscape secured socket layer (hereinafter “SSL”) security mechanism that provides to a remote client system a trusted path between a conventional Web browser program and a Web server. Therefore, optionally and preferably, the client system 10, the portal server 30, and the application servers 70a-z have built-in 128 bit or 40 bit SSL capability and can establish an SSL communication channel between themselves. Other security systems can be employed, such as those described in Bruce Schneir, Applied Crylpography (Addison-Wesley 1996), the contents of which are herein incorporated by reference. For purposes of illustration, however, the systems described herein, including the system 200 depicted in FIG. 2, will be understood to employ public channels.

The system 200 of FIG. 1 further contains a workflow module 54 accessible by the portal 30. The workflow module 54 may direct the presentation of the controls 22 within the portal 20 based upon a user request for information which is received form a business application 80a-z via a corresponding application server 70b. The workflow module 54 allows the services manager of a business application 80a-z to submit (to a user) for approval, approve, or rejection a “user request for information” which is pertinent to an employment service, e.g., a HR process, handled by the business application 80a-z. Individual business applications 80a-z delivering specific employment service functionality can use the workflow module 54 to add items, i.e., controls 22, to an individual user's portal 20. Thus, the workflow module 54 can direct, via portal server 30, for example, the presentation of a list of user requests for information to the user which the user must act upon. The user, upon selecting an item within the portal (via controls 22), may then be presented in the portal 20 with the appropriate business application 40 or 80a-z where the user request can be fulfilled.

The system 200 of FIG. 1 further contains a business rules engine 56 and a business logic module 58. The business rules engine 56 can additionally control the presentation of the portal 20 to the client system 10. The business rules engine 56 provides a mechanism to configure the operation of the business application layer to determine including but not limited to: customer specific business logic, edit checks (to validate user input with specific ranges and proper types), to generate error messages, to calculate eligibility for employment service, e.g., HR benefits, to determine security privileges which in turn can determine which navigation elements (e.g., controls 22) are displayed to the user in the portal 20. The business rules of the business rules engine 56 can be defined using English-language like syntax. The business rules engine 56 may be specialized to the particular requirements of the individual business applications 40 and 80a-z. The business logic module 58 is an application component that can provide specific business application 40 and 80a-z capability, for example an HR business application. The business logic module 58 may encapsulate the form and function of a business application 40 and 80a-z and can be developed using the Java programming language and works in conjunction with the business rules engine 56. The business logic module 58 is generally executed upon a user “navigating” (via controls 22) to the business application 40 and 80a-z. While the workflow module 54, business rules engine 56 and business logic module 58 of the system 200 are shown in FIG. 2 as stand-alone modules separate from any business applications (e.g., 40 and 80a-z), this need not be the case. Accordingly in other embodiments, workflow modules 54, business rules engines 56 and business logic modules 58, which can be designed and implemented to interact with a specific business application, may exist for each business application 40 and 80a-z.

The system 200 of FIG. 2 may further contains a session management module (not shown) to establish and maintain a log of the user's use of the system 200, in addition to other functions which are described below. This log may be stored in the user database 34 and any other suitable database of information. Persons skilled in the art will readily appreciate the wide variety of session management modules which may be utilized in the system 200.

The system 200 of FIG. 2 further contains a data integration module 52. The data integration module 52 can update information stored in at least one of the databases 42 and 82a-z. The data integration module 52 can evaluate (via portal server 30) the information being provided by a user via controls 22 and identify those databases 42 and 82a-z which contain information that needs to be updated in light of the (new) information being provided by the user. For example, if a user informs the system 200, via controls 22, that the user's home address has changed, the data integration module 52 may then identify which application databases 42 and 82a-z contain a user's residential address information. Once these appropriate databases 42 and 82a-z are identified, the data integration module 52 may then direct, via portal server 30 and the appropriate application servers 70a-z, that the user's residential address be updated accordingly. Thus, by utilizing a data integrating module 52 it may be possible for a user to effectuate a change of information, which information is located within a plurality of databases, by only submitting the (new) information once into the system 200.

The system 200 of FIG. 2 further contains an event-based navigation module 50. The event-based navigation module 50 can dictate the presentation of the controls 22 within the portal 20; the event-based navigation module 50 can bundle a plurality of controls 22 to be presented to the user via the portal 20. There can exist relationships between the types of user information that a particular business application may require to be able to fully provide employment services to a user—meaning that a particular business application may require several pieces of user information to provide the user with an employment service. There also can exist relationships between the variously available business applications because more than one business application may required the same user information, or alternatively a change in one piece of user information within one business application may result in the need of new or additional information in a different business application. These relationships between user information and/or business applications can be determined along work-related events and life-related events, wherein the triggering event which is causing a user to provide information to the system 200 is work-related or life-related (i.e., non-work related), respectively. An example of a work-related event would be when a user gets promoted by his or her employer; an example of a life-related event would be when a user has a baby.

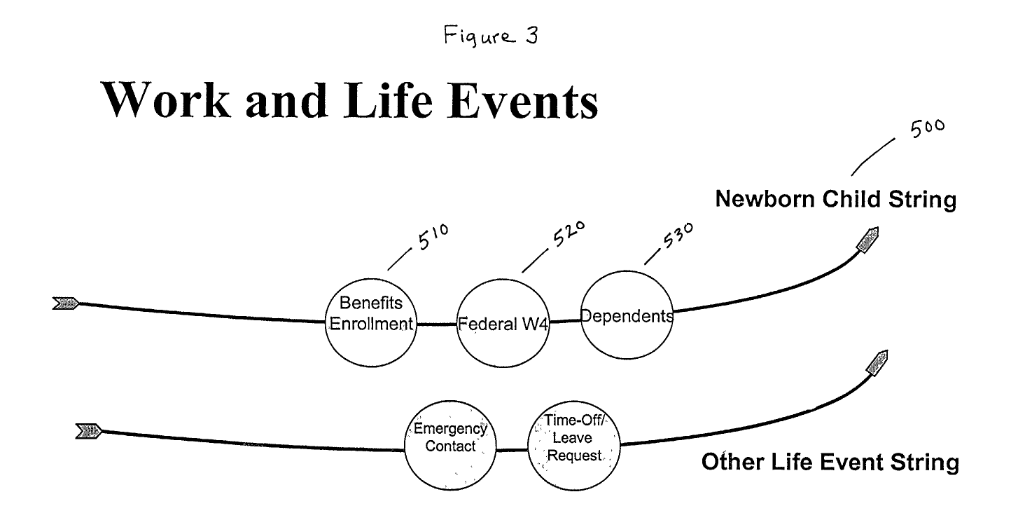

FIG. 3 depicts some examples of work and life events and how a “string” (i.e., a determined relationship) can exist for a particular triggering event. For example, FIG. 3 depicts a newborn child string 500 (the triggering event being the birth of a child) wherein a relationship has been determined to exist between a Benefits Enrollment business application 510, a Federal W4 business application 520 and a Dependents business application 530 (the “Benefits Enrollment,” “Federal W4” and “Dependents” need not exist in separate business application and in some embodiments, one or more of these may exist within a single business application). Once this relationship has been determined for this triggering event and, in some embodiments, the user has informed the system 200 of the occurrence of this triggering information (e.g., a first information), a plurality of controls 22 can be presented to the user via the portal 20 (or user interface 210) so as to be able to solicit the appropriate information (e.g., a second information) from the user to effectuate the changes (of information) that need to be accomplished in the appropriate business application due to the occurrence of the triggering event.

Advantages of composing these separate event “Strings” amongst the plurality of business applications which may be present with the system 200 may be as follows:

User experiences can be configured

Events added/removed, reordered, and offered conditionally

Applications are wrapped in personalization logic—only eligible users see applications

Applications are cleanly isolated from each other

Applications themselves don't know when to commit—configurable unit of work logic

Events can string together old and new application logic

In utilizing a system 200 as depicted FIG. 2, employment management services can be provided to a network user by providing the user interface 210 (or portal 20) having controls 22 to the user so as to be able to access one or more of the business applications 40 and 80a-z, receiving first information (e.g., login information, event-based information, request to access certain business applications 40 and 80a-z, etc.) from the user via the controls 22 and processing the received information to provide an employment service to the user. In some embodiments of the system 200, controls 22 may be presented to the user via the user interface 210 to access at least one of the business applications 40 and 80a-z. These controls 22 may be presented to the user based upon the first information received from the user and then second information may then be received from the user via these controls. The processing of the information by the appropriate business application 40 or 80a-z may require the business application 40 or 80a-z to access an application database 42 or 82a-z, respectively, to gather additional user information and/or store the user information which has been provided by the user.

As discussed above, in some embodiments, a plurality of controls 22 may be bundled, as directed by the event-based navigation module 50, and presented to the user via the user interface 210. These plurality of controls 22 may be presented to the user via user interface 210 to access at least one of the business applications 40 and 80a-z.

A business application such as 40 or 80a-z may initiate a user request for information via an appropriate application server 70a-z, network 60 (depend upon where the request is emanating from) and portal server 30. The portal server 30 may then direct the presentation of controls 22 via the user interface 210 so that the user may access the appropriate business application to address (i.e., provide information) the initiated user request for information. The portal server 30 can convert the data content being provided by the business applications 40 and 80a-z, through the utilization of XML files, so that the controls 22 of the user interface 210 can be presented to the user in a common and consistent format (i.e., the plurality of controls 22 have the same look and feel). The presentation of the plurality of controls 22 having a common format may further be driven by the event-based navigation modules 50 as discussed herein.

Upon providing an employment services to the user, the portal server 30 may initiate the delivery of a message to the user via the user interface 210 confirming the employment service has been provided to the user.

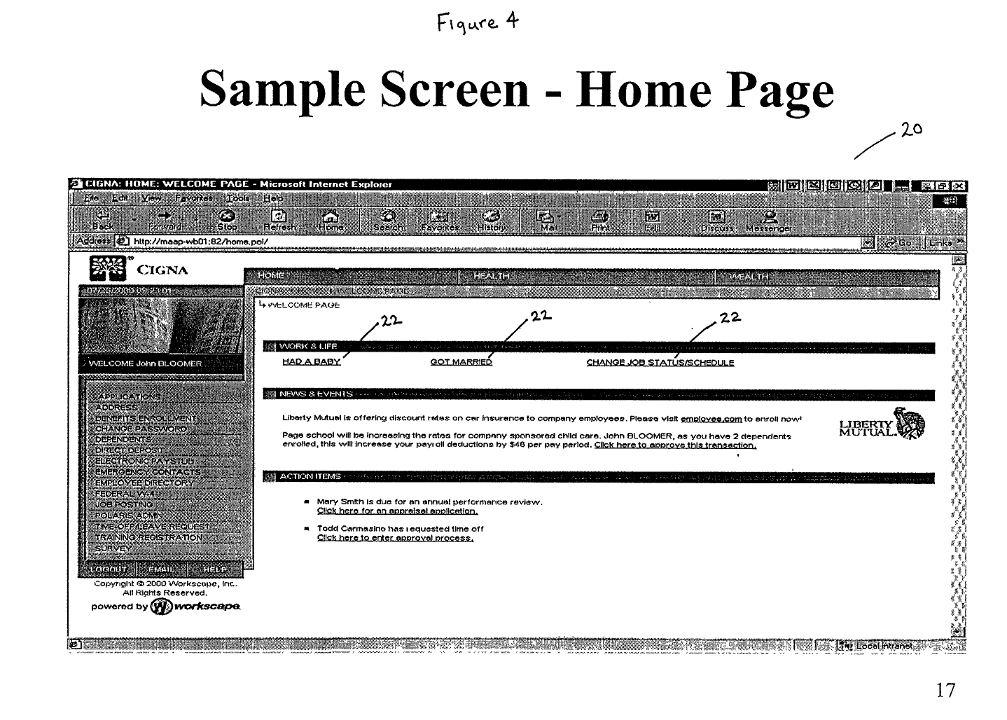

FIG. 4 depicts how controls 22 can be presented to a user via a portal 20 (or user interface) for the user to identify the system 200 of the occurrence of a work-related or life-related event. The activation of the controls 22 depicted in FIG. 4 can cause the activation of the event-base navigation module 50 which may direct the presentation of further controls 22 via the portal 20 which relate to the identified triggering event.

The event-based navigation module 50 (like most of the modules, applications and databases as discussed herein make take the form as a software program) can map out the relationships that exist between data (i.e., information) about an individual user, business applications (e.g., 40 and 80a-z), informational content, and the context of business transactions (i.e., the employment services which the business applications are able to provide) to be defined and used to present a bundled plurality of controls 22 to be presented to the user via the user interface 210 (or portal 20). By utilizing an event-based navigation module 50 as described herein, the user can be presented with the “right information at the right time” once a triggering event has been, e.g., the birth of child.

The facts (i.e., information) that are known about an individual user such as their age, profession, employment status, age and number of dependents, past medical conditions and address can be stored in a database such as user database 34, which may or may not be a relational database, or alternatively, such user information can be stored in a server (not shown). A server which can be suitable for storing such user information may be a LDAP server that is capable of responding to the Lightweight Directory Access Protocol wherein the information is stored in a tree form.

The facts (i.e., information) about the business applications (e.g., 40 and 80a-z), which may be required for the event-based navigation module 50, can include the information which is considered mandatory or optional for a particular user, the security privileges needed to execute the business application (e.g., in a manager self-service application the user must be a manager), and the sequencing of business applications components (business application A must be executed before business application B) can be stored in a database, such as a user database 34 for example, which can be a tree-structure that is maintained within a relational database or, alternatively, this business application relational information may be stored within an XML file.

Informational content, either instructional or help related, can be stored as text fragments after being tagged with key phrases and stored in relational database (such as user database 34, for example) or within a computer system's file structure. A thesaurus-like translation tagging tool allows aliases to be defined to convert the meta tags between customer specific language to the employment management services system features.

A set of business rules, found within the business rules engine 56, for example, can operate to continuously matching known facts about users with the configuration of the specific business applications and their content. The resulting text fragments and navigation aides can provide the user with an interactive user interface 210 (or portal 20) having controls 22 which are personalized to the individual user with specific event-base business application content.

In one embodiment, the events-based navigation module 50 can bundle a plurality of controls 22 to be presented to the user via the portal 20 (or interface 210) based upon information received from the user. The information received from the user can be the identification of an event (i.e., a triggering event). In some embodiments, these bundled plurality of controls 22 can be associated with a plurality of business applications 40 and 80a-z.

Many of modules, databases and applications of the system 200, while shown as stand-alone elements of the system 200, can exist as software programs and in many preferred embodiments do exist as software programs. As such, persons skilled in the art will readily appreciate that the components of the system as depicted in FIG. 2 can exist in a wide variety of arrangements and configurations. For example, in one embodiment the business rules engine 56 and business logic module 58 can be arranged as a single module, which may exist separately from the portal server 30 or be integrated within the portal server 30. Similarly, for example, the event-based navigation module 50, in some embodiments, may also be integrated within the portal 30 and thus not exists as a separate component with the system. Persons skilled in the art will appreciate the various forms that a system such as system 200 can take.

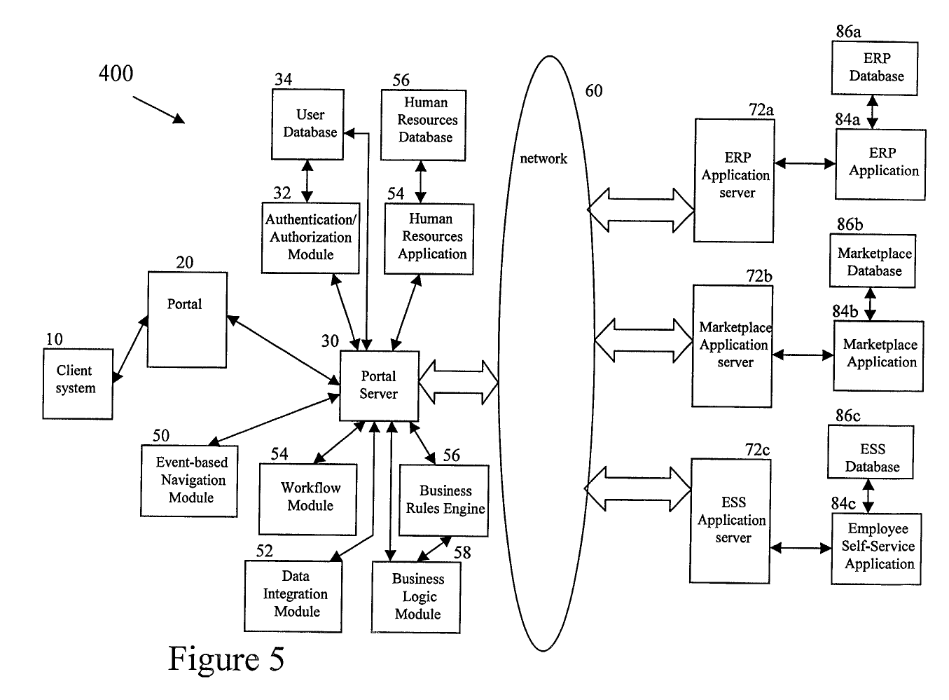

FIG. 5 illustrates a system 400 for providing employment management services via a network to assist at least one services manager in managing the employment services being offered to a user. System 400 comprises a Human Resources Application 54, a Human Resources Database 56, an ERP Application Server 72a, an ERP Application 84a, an ERP Database 86a, a Marketplace Application Server 72b, a Marketplace Application 84b, a Marketplace Database 86b, an Employee Self-Service Application Server 72c, an Employee Self-Service Application 84c and an Employee Self-Service Database 86. The system 400 as depicted can represent a system wherein the Human Resources Application 54 and Human Resources Database 56 exist within a network which is more local to the portal server 30. For example, the connections between the portal 30 and the Human Resources Application 54 and Human Resources Database 56 could represent a LAN communications system. The ERP Application Server 72a, ERP Application 84a, ERP Database 86a, Marketplace Application Server 72b, Marketplace Application 84b, Marketplace Database 86b, Employee Self-Service Application Server 72c, Employee Self-Service Application 84c and Employee Self-Service Database 86, on the other hand, may be accessible via network 60, which is widely distributed relative to the portal server 30. Network 60 may be a WAN or the Internet, for example. The system 400 of FIG. 4 may be indicative of an arrangement where the human resources functions of an employer is retained within the employer's computer network (i.e., be maintained in-house) and the functions of ERP, Marketplace and ESS of an employer have been contracted to other third parties (i.e., these functions have been outsourced to third parties).

The next sections will describe in further detail each of the logical layers of the systems and methods for providing employment management services over a network as described herein:

### Interaction Layer

The Interaction Layer within the inventor's Enterprise Architecture may serve two major purposes. First, it may provide access to the underlying business applications through a variety of access media types and second, it may perform all the required security, authentication and authorization services required to ensure that only valid users are accessing the applications.

### Multi-Media Access

At the most basic level, employee-based business applications can be delivered with access via a Web browser. Web browsers have become the ubiquitous access method for most modem applications. In addition to accessing a Web browser from an employee desktop, Web browsers can be deployed in kiosks for those employees who may not have access to a Web browser on their desktop. Using the Web is the most common means of accessing an employee portal, but is certainly not the only one available. Access to employee-facing applications can be from a phone using Interactive Voice Response (IVR) technology coupled with advanced speech recognition technology. Wireless access to the portal applications can be achieved through Web-enabled Personal Digital Assistants (PDA's) or from Web-enabled digital telephones. Capabilities will soon exist that will allow access to the portal applications from a set-top box attached to a home television via cable services. The full benefits of employee-facing applications can only be fully realized when all users have access to them. Providing the widest possible range of access options enables customers to fully leverage these applications and content services.

### Business Application Logic Layer

The Business Application Logic layer in the systems and methods described herein may include all of the business applications, rules, modules and workflow required to deliver the business applications accessed through the portal 20 (or user interface 210). This set of rules and logic of these components are based on the services manager's business requirements. For example, within a Manager Self-Service business application, a manager's recommended merit and bonus awards should not exceed specific percentages on an aggregate or individual basis. Salary plans must also undergo a review and approval process by senior management prior to implementation.

The session management module (not shown) and the business logic module 58 are two core components of the Business Application Layer. The session management module functions such that a user request from an Internet/Intranet site triggers the start of a secure user session (i.e. logon) via the security module. A user may be passed though an authentication process via an authentication module 32 that can dynamically create a session profile. The session management module may also handles the persistent data-storage pool, statistics collection, error handling, and frame interfaces. The session management module may also be called when the user selects a control 22 to access an application group (a plurality of business applications 40 and 80a-z), a business application 40 or 80a-z, or any control 22 which is not by the current business application.

The business logic module 58 of the Application Layer may manage the user interface 210 and the business rules engine 56 within a business application 40 or 80a-z. It can utilize a state table to determine whether to create and send a dynamic page to the browser or to call a Data Integration application object to process a business function.

Merging dynamic content, from application data sources, and HTML templates, this tier may then creates the personalized HTML pages (or XML pages) that can be sent to the user. When a business function is processed, data may be returned from the web request. The data may then be passed to the requested Data Integration application object.

### Industry Standard Components

Within the Business Application Logic Layer, there are a variety of shared services and applications running to deliver the functions requested by the user. In addition to business applications such as Benefits Enrollment, Personal Profile Management, or Compensation Planning, there are industry standard, best-of-breed shared business application services such as the Rules or Workflow Engine. The major components are described below:

### Productivity Tools

Productivity tools may be incorporated into the systems and methods previously described so as to provide a more efficient and user-friendly portal environment:

Report Writer

Instant Messaging

Calendar

Chat

### Business Applications

The Business Application Servers (e.g., 70a-z) may run the actual business applications delivered through the portal 20 (and /or portal server 30). These business applications can leverage the other business application servers within the business logic layer. The business applications may include, but are not limited to:

ESS—Employee Self Service

MSS—Manager Self Service

WFM—Workforce Management

Legacy Business Applications

Third Party Business Applications

Marketplace Business Application

### Marketplace Business Applications

The marketplace applications which can be delivered via system 200 can provide employees (i.e., users) with access to a variety of employer sponsored content and transactions. Examples of the marketplace business applications which can be utilized include:

Welcome—A Welcome business application can enable the employer to connect with their employees through company messages, press releases and important announcements in real time or near-real time.

Money—A Money business application (or channel) can provide tools to manage personal finances, from on-line bill payment to pre and post-tax planning for retirement. Plus, there is a personalization element where the employee can customize the channel with what interests them, such as the daily stock market summary or a “my portfolio”.

Health—A Health business application (or channel) can provide employees across the entire organization with the ability to assess the health plans that are available to them, manage their enrollment, update their information, and get answers to their health-related questions. With permission, recording these events can prompt special offers and relevant information that may be of interest.

HomeLife—A HomeLife business application (or channel) can provide employees across the entire organization with ability to access information regarding childcare, pets, buying a home, finding an apartment . . . everything your employee needs to take care of the important things in life. A wealth of resources are contained in the HomeLife channel to take care of everyday essentials.

Leisure—A Leisure business application (or channel) can provide employees across the entire organization with ability to access information regarding vacation information and the ability to make vacation-related reservations.

Volunteering services to the local community. The system 200 provides a plethora of information to users regarding volunteering opportunities.

Career—Through a Carrer business application (or channel) employees can fulfill their personal and professional development goals, whether it is through a formal degree program or a Stephen Covey course on Seven Habits of Highly Effective People. New job postings, self-improvement resources for work and life, training registration, and more—to empower employees to reach their potential.

Workplace—through a Workplace business application (or channel) an employer can build a workplace where all the relevant tools and resources are available by department and role. For instance, a sales manager will have access to sales report templates in addition to the Compensation Planner.

Shopping—through a Shopping business application (or channel) employers can leverage their purchasing power to the benefit of their employees, thus enabling their employees to take advantage of sizable discounts on goods and services.

### Framework

Enterprise Java Beans—the business applications may be built around the Sun Microsystems's Enterprise Java Bean (EJB) technology, and as such, in some embodiments, the portal server 30 can be the iPlanet Portal Server previously discussed. The iPlanet Portal Server is capable of storing and managing the data objects to ensure scalability and performance.

Business Rules—configurable business rules can be created for the different business applications running in the portal environment using the business rules engine 56.

IVR Services—This is the basic phone interface allows employees to check on and execute routine event-based transactions.

Workflow Module—At the core of any event-based business application is a workflow engine. The Workflow module 54 allows life event processes to follow company specified paths for approvals and information collection.

Directory Services—The LDAP Server (not shown) may manage user directories for authentication and authorization purposes.

Knowledgebase Server—The knowledgebase may maintain industry and company-specific knowledge related to the various events supported through the portal application. This knowledgebase can be populated with existing company data or utilize external content.

XML Gateway—Exchanging data between applications and external systems leverages XML technology. The portal server 30 may be dedicated to managing the XML traffic flow throughout the architecture, e.g., between the business applications and the portal 20 or user interface 210.

### Business Logic Layer Flexibility

The Business Logic Layer is also highly configurable as a result of the business rules engine 56, which plays a key role in the business application interactions. In leveraging a state-of-the-art rules engine, the system 200 can simplify the configurability of the business applications while providing a powerful tool to manage complex business logic. Some of the benefits of this business logic configurability, as may be provided for within a business logic module 58 are described below.

Isolated rules are easier to write, debug, and maintain

Clients can use a web-based product to edit business rules

Upgraded applications can continue to use existing, tested, rule sets

By executing rules in the clustered application server tier, additional computing power can be added as needed

Component-based architecture allows solutions to be mixed and matched

Portal session management is separate from Application Server based functionality

Users authenticate once to portal, and are given a personalized experience

Application Server performs all business logic and workflow

Can be reused for IVR-based solutions

Separate Business Objects from Persistence Storage

Distinct layer for mapping to local replicated data, or distant Enterprise or third party data

### Data Access Layer

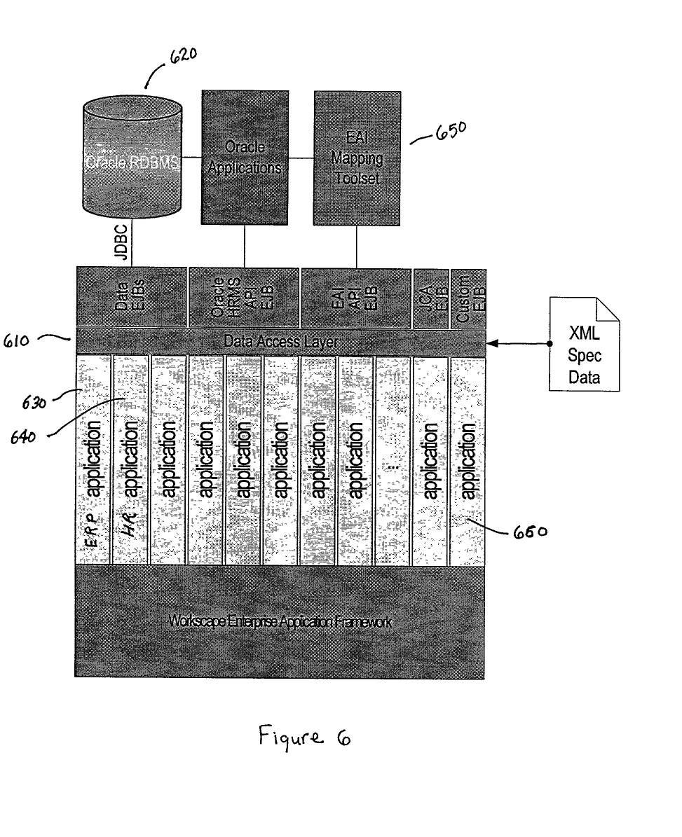

Referring to FIG. 6, the data access layer 610 can provide the business application logic layer a means to manipulate data maintained within one or more relational database management systems (RDBMS) 620, data files including XML formatted data files, enterprise resource planning systems (ERP) 630, human resource management systems (HRMS) 640, or other application systems 660 through a portal server 30 or other enterprise application integration tool (not shown). The data access layer 610 can contain a system whereby each individual business application has a setting from where and to where data will be retrieved and stored. The setting is contained within a configuration file 650 (XML or other text file) where by the business application's data requirements are mapped to the source/destination's data. Upon execution, the business application layer will request data from the data access layer whereby the data access layer will determine which data source to use. The data access layer will make a request appropriate to the data source (either through direct access in the case of data files, SQL language for RDBMS or proprietary application programming interfaces (APIs) for the ERP, HRMS, or EAI systems). The request will transform the data into/out of the format the user interface 210 uses internally.

The systems and methods described herein thus may be fully integrated with the leading commercial enterprise software products including PeopleSoft and SAP, to allow direct employee access to information and services. And it integrates equally well with corporate databases, legacy hosts and remote third-party service providers on a real-time basis. This tier may execute back-end functions and business rules using the parameters stored in the business logic. These functions can integrate with various backend systems through use of ODBC, DLL, COM, and terminal emulation and published APIs in addition to using our EAI technology. The Data Access Layer may return to the business logic component an event that identifies the next state to perform. So, any employee transaction can occur instantaneously across all information systems.

### Configurability

The systems and methods described herein can adopt an object-oriented approach to dealing with data stored in back-end systems or external supplier databases. They may also utilize XML to exchange information between the application business objects and data contained within persistent storage. Persistent storage is the ERP, legacy system, flat file, system of record, or replicated database where data may be stored at rest. Business objects are the objects all applications and business rules operate upon. The systems and methods described herein can isolate the business objects from persistent storage in a storage functional layer. The systems and methods described herein can use XML to define the integration point between business objects and persistent storage. This allows implementation teams to easily perform all mapping, messaging, and encryption work in a single well-defined layer within the architecture.

### Third-Party Application Integration

All business applications can get deployed within event control structures. Even a business application that stands alone as a complete transaction can be deployed as an event of one application. Most strings contain several applications, and most business applications can be deployed within several strings, for example the W-4 application is used in “New Hire” events, as well as the “Had a Baby” event.

The control structure may include the run-time code managing the users session, and tracking progress through events; as well as the specifications constructed in advance by system administrators. System administrators can specify what applications make up an event, the order of applications, the rules that control access to applications, for example, only US-based employees can use the W-4 application; the rules that govern availability to applications, such as those based on completing other steps within the event; and when to commit results to the database, when step 3 is finished, have applications 1, 2, and 3 commit.

The ability to group business applications together into a user experience allows administrators to solve a wide range of problems. The ability of event strings to restrict the use of some applications based on the user's profile means each event definition can be used by many groups. The ability of event strings to restrict the use of some applications until other steps within the string have been successfully completed means many lightweight workflow requirements can be accommodated simply. The ability to control when to commit interim results to the database means administrators can easily tune how much information is held within the users session, and how frequently to touch the systems of record.

### Security

The servers of the system 20 can be maintained in a physical environment that ensures their ability to meet 24×7 client requirements. These facilities can offer the widest range of physical security features, including state-of-the-art smoke detection and fire suppression systems, motion sensors, 24×7 secured access, video camera surveillance and security breach alarms. Access to the facility is granted only to pre-approved members of a team. Entry into the facility may be granted only after presenting positive picture identification to on-site security guards. Identity and access authority is validated by security using on-site computer systems. After entering the data center floor, all activity is monitored using video surveillance equipment.

Whether accessing the business applications, databases and servers of system 200 via the Internet or a private intranet, client data can be protected by multiple and redundant firewalls.

Security of individual user data is typically managed at the access point—through use of employee ID numbers and a client-specific Personal Identification Numbers (PIN's). Employee-specific PINs can also be provided to protect confidential employee data. Individual data security is handled through defined time-outs and disabling browser functions.

### Application Development Environment

The business applications can be developed via a modified standard Rational Unified Process (RUP) methodology to slightly to better accommodate product development. Because applications can rely on the framework to handle many standard chores, developers can implement new functionality quickly. The developer of the systems and methods disclosed herein starts by specifying application requirements, including use case descriptions, web designs, basic validation rules, and error messages. Once we know how applications are suppose to behave we design any new business objects required, and generate the XML mapping to persistent storage.

Applications only need to support three methods, sometimes referred to as functions or subroutines, when deployed in the framework:

Present themselves

Validate user input

Commit interim results to persistent memory

To present themselves, applications need to load user data into the appropriate business objects, and generate an XML representation of this data, and the widgets to allow interaction with this data.

To validate user input, applications just have to ensure that this user's business objects are accessible, and call the rules engine to perform all standard and user specific rules. Violations are reported via XML containing error messages; success yields updated business objects and XML containing a success message.

To commit, applications just have to ensure their business objects have been written to persistence successfully. Most of this work is pushed off to the designers and implementers of business objects, a sub-specialty in the development process.

Applications may be deployed within event “strings,” control structures that determine when they get called, when the user input should be validated, and when a unit of work is complete so an application should try to commit its results.

### Application Configurability

The system 200 may make significant use of XML/XSL technology in allowing for a highly configurable look and feel of web applications as present in the portal 20. Some of the benefits of this configurable architecture are described below:

Different looks can be applied to the same tested, reusable application

Designers can change web screens dramatically, changing all of the text, graphic elements, and even functional elements—for example, radio buttons can be replaced with drop-down lists

Browser specific web pages are supported. The session manager determines the type and version of the user's browser and retrieves the appropriate XSL for each application

Designers are free to hide sensitive data elements from users. A single application that displays employee information, for example, can support a wide variety of business functions, simply by redesigning which data elements to display on each screen. Because the XML/XSL transformation takes place in the Business Rules tier, hidden fields are never sent beyond the server

XSL controls not only the appearance of application elements, but also navigational elements. All menus of available functionality are provided as XML, and can also be redesigned or hidden just like application elements

Upgraded applications that support additional XML elements run seamlessly under old XSL style sheets

These different looks can support different companies, divisions, or participation groups. Internationalization is primarily accommodated through XSL redesign

The employee portal will use XSL to transform the application generated XML into web centric HTML pages. Future releases will transform the internal XML for PDA's, TV set top boxes, and IVR systems

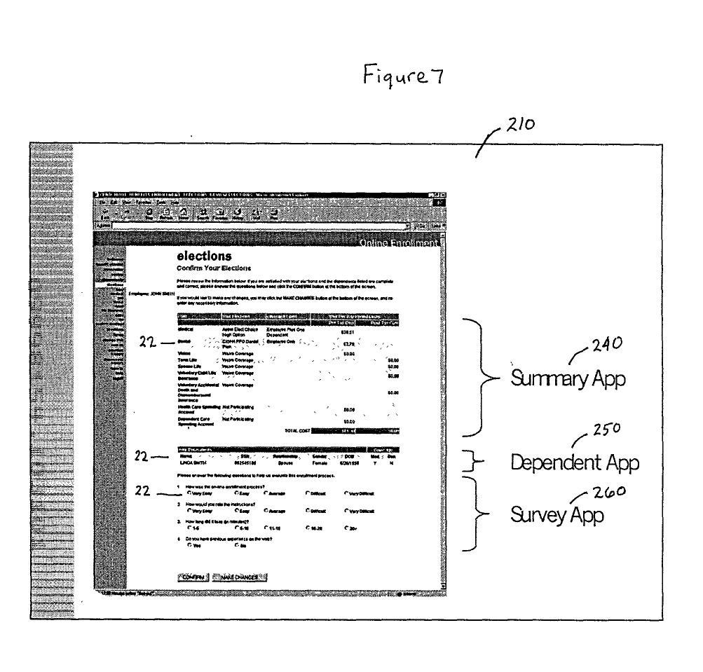

FIG. 7 illustrates how a plurality of controls 22 to access a plurality of business applications 240, 250 and 260 can be presented in the user interface 210 having a consistent and common format.

### Roles-Based Personalization

The portal experience can be highly configurable to suit the needs of individual preferences and roles within the organization. The standard employee portal breaks down access to applications and content through the use of “channels”. Examples of portal channels include Money, Health and Community, as discussed above. The specific layout of information may also be customized by the end user to include content feeds from the Internet or simplified access to internal applications. The employer may choose to dedicate specific portal real estate to display current events in the company or other important information tailored to the specific user role. This personalization flexibility gives user the ability to create a “MySite” view of the employee application.

### Work and Life Event Based Navigation

Each delivered business application may be focused around specific employee work and life events, as discussed above. Transactions embedded in the portal 20 can take place based on an activity such as job transfer and promotion or event like marriage or birth that takes place in the work or life of the employee. Work and life events can apply to all employee populations defined by the client. An integral piece of the work and life event organization of applications within the portal are the workflow engine and rules engine described in the business application logic layer below.

### International Considerations

The Interaction Layer is completely separated from the Business Logic Layer. That permits that use of specific XSL for each market (e.g., country) so as to be able to deliver appropriate languages, color schemes, field formats such as decimal or comma separators, for extra long number fields such as Italian Lira or Japanese Yen. Also, the rules engine can be tailored as appropriate to govern the specific rules that display the data via the portal 20 according to an individual country's privacy laws. Additionally, user preferences may be tracked starting at the initial log in. These user preferences can include preferred language, device type, country affiliation, and group identification. These are used for appropriate display of information. The country affiliation can be used to drive the rules mentioned above. The device type can deal with European WAP or Japanese iMode phones as well as other devices such as PDA's or other Internet appliances.

Many additional changes in the systems and methods for providing employment management services as described herein, can be made by those skilled in the art. Accordingly, it will be understood that the following claims are not to be limited to the embodiments disclosed herein, and can include practices otherwise than specifically described, and are to be interpreted as broadly as allowed under the law.

What is claimed is:

1. A method for providing employment management services to a network user, said method comprising:
providing a user interface to said user to access said employment management services, wherein said user interface comprises controls, and wherein said employment management services comprise at least one of the following business applications: an employee self-service application, a manager self-service application, a workforce management application, a payroll services application, a human resources services application, an enterprise resource planning services application and a marketplace services application;
receiving first information from said user via said controls; and
processing said received information to provide an employment service to said user.

2. A method in accordance with claim 1, wherein said user interface further comprises a portal and wherein said controls of said user interface are provided with said portal.

3. A method in accordance with claim 1, further comprising:
presenting controls to said user via said user interface to access said at least one business application, wherein said controls are presented to said user based upon said first information received from said user; and
receiving second information from said user via said controls, wherein said first and second information is processed to provide an employment service to said user.

4. A method in accordance with claim 3, further comprising bundling a plurality of controls, wherein said bundled plurality of controls are presented to said user via user interface to access at least one business application.

5. A method in accordance with claim 4, further comprising utilizing an events-based navigation module to determine said bundling of said plurality of controls.

6. A method in accordance with claim 1, further comprising:
receiving a user request for information from said at least one business application;
presenting controls to said user via said user interface to access said at least one business application, wherein said controls are presented to said user based upon said user request for information; and
receiving second information from said user via said controls, wherein said first and second information is processed to provide an employment service to said user.

7. A method in accordance with claim 1, further comprising:
presenting said controls to said user via said user interface to access a plurality of business applications, wherein said controls to access said plurality of business applications are presented to said user in a common format.

8. A method in accordance with claim 7, further comprising bundling a plurality of controls, wherein said bundled plurality of controls are presented to said user via said user interface to access said plurality of business applications.

9. A method in accordance with claim 8, further comprising utilizing an events-based navigation module to determine said bundling of said plurality of controls.

10. A method in accordance with claim 7, wherein said controls to access said plurality of business applications are presented to said user based upon said first information received from said user, and wherein said first and second information is processed to provide an employment service to said user.

11. A method in accordance with claim 7, further comprising:
receiving a user request for information from at least one business application, and
wherein said controls are presented to said user based upon said user request for information received from said at least one business application.

12. A method in accordance with claim 1, further comprising:
establishing a user identity based upon at least a portion of said first information received from said user; and
determining a user authorization for said user, wherein said user authorization is based upon said established user identity.

13. A method in accordance with claim 1, wherein said processing of said received information comprises:
accessing at least one database of information; and
updating said at least one database of information based upon said information received from said user.

14. A method in accordance with claim 1, further comprising:
accessing at least one database of information to identify at least one business application which is associated with at least a portion of said information received from said user; and
providing said portion of said received information to said at least one identified business application, wherein said at least one identified business application module processes said provided information to provide an employment service to said user.

15. A method in accordance with claim 14, wherein said at least one business application accesses a database of information having data concerning said user to process said provided information.

16. A method in accordance with claim 1, further comprising:
storing at least a portion of said information received from said user in at least one database of information.

17. A method in accordance with claim 1, further comprising:
updating at least one database of information with at least a portion of said information received from said user.

18. A method in accordance with claim 1, further comprising:
updating a plurality of databases of information with at least a portion of said information received from said user,
wherein said plurality of databases of information each contain information relating to said user.

19. A method in accordance with claim 1, further comprising:
maintaining a user session log within at least one database to record said employment service provided to said user.

20. A method in accordance with claim 1, further comprising:
delivering a message via said user interface confirming said employment service has been provided to said user.

21. A method in accordance with claim 1, further comprising:
accessing a first database of information to verify a user identity and a user authorization of said user based upon at least a portion of said information received from said user;
accessing a second database of information to identify said at least one business application module which is associated with at least a portion of said information received from said user; and
providing said portion of said received information to said at least one identified business application module, wherein said at least one identified business application module processes said provided information to provide an employment service to said user.

22. A method in accordance with claim 21, wherein said at least one identified business application module accessing a third database of information in processing said provided information, wherein said third database of information includes data associated with said user.

23. A system for providing employment management services, the system comprising:
a portal server hosting at least a portion of an employment management services accessible to a user via a client system;
at least one business application, wherein said at least one business application concerns an employment service which is offered to said user;
at least one database of information concerning an employment service which is offered to said user;
said employment management services comprising a user interface comprising controls whereby said user submits information, said employment management services being available via a network to assist at least one services manager in managing employment services offered to said user.

24. A system in accordance with claim 23, wherein said user interface further comprises a portal and wherein said controls of said user interface are provided within said portal.

25. A system in accordance with claim 23, wherein said at least one services manager includes an employer of said user.

26. A system in accordance with claim 23, wherein said at least one services manager includes a third party supplier who provides services to said user.

27. A system in accordance with claim 23, wherein said at least one business application includes at least one of the following:
an employee self-service application,
a manager self-service application,
a workforce management application,
a payroll services application, a human resources services application,
an enterprise resource planning services application and
a marketplace services application.

28. A system in accordance with claim 23, wherein said client system includes at least one of the following:
a computer, a telephone,
a wireless communication device,
an information kiosk,
a fax device,
a television and
a call center.

29. A system in accordance with claim 23, wherein said user interface further comprises:
an authentication module to authenticate an identity of said user, wherein said authentication module compares said submitted information to information stored in said at least one database of information; and
an authorization module to determine which employment services are available to said user.

30. A system in accordance with claim 29, wherein said user interface further comprises a security module to protect information exchanged within said system.

31. A system in accordance with claim 30, wherein said security module utilizes a secure sockets layer protocol.

32. A system in accordance with claim 23, further comprising:
a user database, wherein said user database includes data associated with said user; and
an application database, wherein said application database includes data associated with said user and which is relevant to said at least one business application.

33. A system in accordance with claim 23, the system further comprising a workflow module, wherein said workflow module directs the presentation of said controls within said user interface based upon a received user request for information.

34. A system in accordance with claim 23, the system further comprising a business rules engine, wherein said business rules engine controls the presentation of said user interface.

35. A system in accordance with claim 35, the system further comprising a business logic module.

36. A system in accordance with claim 23, the system further comprising a session management module.

37. A system in accordance with claim 23, the system further comprising a data integration module to update information stored in said at least one database of information.

38. A system in accordance with claim 23, the system further comprising an event-based navigation module, wherein said events-based navigation module bundles a plurality of controls to be presented to said user via said user interface.

39. A system in accordance with claim 38, wherein said event-based navigation module bundles said plurality of controls to be presented to said user via said user interface based upon information received from said user.

40. A system in accordance with claim 38, wherein said bundled plurality of controls are associated with a plurality of business applications.

41. A system in accordance with claim 23, wherein said employee services management service further comprises
at least one application server to communicate with said portal server and said at least one business application; and
at least one application database of information, wherein said at least one application database of information includes data associated with said user.

42. A system in accordance with claim 23, the system further comprising an event-based navigation module, wherein said events-based navigation module bundles a plurality of controls to be presented to said user via said user interface.

43. A system in accordance with claim 42, wherein said bundled plurality of controls are associated with a plurality of business applications.

44. A system in accordance with claim 23, the system further comprising a data integration module to update information stored in said at least one application database of information.

45. A system in accordance with claim 23, wherein said employee services management service further comprises:
a business application logic layer comprising at least one application module, wherein said at least one application module relates to a service available to at least one user, and wherein said business application level delivers said at least one application module to said portal; and
a data access layer to retrieve and store information.
